(19) United States
(12) Patent Application Publication
(10) Pub. No.: US 2026/0361805 A1
(43) Pub. Date: Nov. 12, 2026

(54) PACKET PARSER GENERATING HEADER STACK ARRANGEMENT INFORMATION

(71) Applicant: Dreambig Semiconductor Inc., San Jose, CA (US)

(72) Inventors: Pranab Ghosh, Pleasanton, CA (US); Faisal Masood, San Jose, CA (US); Imtiaz Ahmed, Pleasanton, CA (US); Sohail A. Syed, San Jose, CA (US)

(73) Assignee: Dreambig Semiconductor Inc., San Jose, CA (US)

(21) Appl. No.: 19/199,579

(22) Filed: May 6, 2025

(51) Int. Cl. H04L 69/22

(52) U.S. Cl. CPC H04L 69/22

(57) ABSTRACT

A network packet parser circuit is provided comprising: logic to identify header types within a network packet; logic to determine offsets of the identified header types from a payload of the packet; and logic to generate header arrangement information that indicates packet header types within the network packet and packet header locations within the packet header.

### BACKGROUND

A data processing unit (DPU) is a specialized processor that offloads certain complex functions, such as networking, storage, and/or security, from a general-purpose computing system, e.g., a central processing unit (CPU). A DPU specialized for networking functions (a ‘networking DPU’) is often used in a high-performance network environment to offload complex networking responsibilities from a general-purpose computing system. Networking DPUs also have been referred to as ‘SmartNICs.’ A networking DPU includes programmable logic that manages certain networking tasks. These tasks may involve determining information about the identity and arrangement of network protocol headers for protocols such as Ethernet, IPv4, or TCP within network packets received over a network and modifying the headers based on predetermined rules.

A network packet typically includes at least two kinds of information: a header stack and a payload. A header stack is a collection of headers included within a packet. Headers in a header stack correspond to different network protocols used in portions of a network over which the packet is transmitted and typically include information about a packet's content, origin, and destination. Different header stacks that traverse different portions of a network may include different combinations of headers. The information and its arrangement within individual headers within a header stack may vary with protocol type. The payload includes the actual data transmitted within the packet.

A networking DPU generally includes hardware parser logic, often called a parser, that identifies and extracts fields within a packet. A typical parser inspects individual packets received over a network to determine protocol types and locations of headers within a header stack of the packet. A typical parser searches a packet to locate known header types and known header fields to identify a sequence of headers within a packet. A typical parser identifies each header's location within a packet as an offset distance from a known packet location, such as the start of the packet, in terms of the number of bits, bytes, or words between the header and the known location.

A networking DPU typically includes configurable processing logic to classify a packet based upon one or more headers identified within its header stack, use the classification to match the packet against a pre-defined set of rules, and perform a packet processing action on information from an extracted field, based upon a rule that matches the classification. Some rules may require multiple packet processing actions to be performed in a sequence. Networking DPUs have been configured to implement a multi-stage pipeline to perform a sequence of packet processing actions in which a sequence of pipeline stages performs a sequence of processing actions on fields extracted from headers within a header stack. A pipeline stage may use offset information within a parser output to locate fields to extract from a header for processing action at the pipeline stage. A pipeline stage also may modify a header stack by inserting headers into or removing headers from the header stack. These changes to the header stack can result in changes in the offset for one or more headers and corresponding fields that may be extracted for processing at a subsequent pipeline stage. Reparsing of a packet sometimes has been performed between pipeline stages to determine changed offsets between headers that a downstream pipeline stage can use to locate fields within the packet's modified header stack to be extracted for additional processing action at a downstream pipeline stage.

### SUMMARY

In first example aspect, a network packet parser circuit is provided. The parser circuit includes logic to identify header types within a network packet, logic to determine offsets of the identified header types from a payload of the packet, and logic to generate header arrangement information that indicates packet header types within the network packet and packet header locations within the packet header.

In a second example aspect, a network packet parser circuit is provided. The parser includes logic identify header types within a network packet and logic to determine offsets of the identified header types from a payload of the packet. The parser includes logic to insert header type information in a predetermined packet identification type schema to produce a packet header type data structure that corresponds to the network packet, based on the identified packet header types. The parser includes logic to insert header offset information in a predetermined header offset schema to produce an offset data structure that corresponds to the network packet, based on the determined offsets.

In a third example aspect, a method to parse a network packet is provided. A logic circuit is used to identify header types within a network packet. A logic circuit is used to determine offsets of the identified header types from a payload of the packet. A logic circuit is used to insert header type information in a predetermined header identification type schema to produce a header type data structure that corresponds to the network packet, based upon the identified packet header types. A logic circuit is used to insert header offset information in a predetermined header offset schema to produce an offset data structure that corresponds to the network packet, based upon the determined offsets of the identified header types from a payload of the packet.

In fourth example aspect, network packet processing circuit is provided to modify a packet received over a network that includes a header stack and a payload. The network packet processing circuit includes a packet parser circuit. The parser includes logic identify header types within a network packet and logic to determine offsets of the identified header types from a payload of the packet. The parser includes logic to insert header type information in a predetermined packet identification type schema to produce a packet header type data structure that corresponds to the network packet, based on the identified packet header types. The parser includes logic to insert header offset information in a predetermined header offset schema to produce an offset data structure that corresponds to the network packet, based on the determined offsets. The network packet processing circuit a processor circuit operatively coupled to a memory that includes a set of computer program instructions to cause the processor circuit to perform a set of operations. The operations include using the header type data structure and the offset data structure to locate a first header within a header stack of the network packet, modifying the located first header in the header stack to produce a modified header stack, and updating at least one of the header type data structure or the offset data structure based upon the modified header stack The operations further include using the updated at least one of the header type data structure or the offset data structure to locate a second header within the modified header stack, and modifying the located second header in the modified header stack to produce a further modified header stack.

### BRIEF DESCRIPTION OF THE DRAWINGS

Aspects of the present disclosure are best understood from the following detailed description when read with the accompanying figures. It is emphasized that various features are not drawn to scale in accordance with the standard practice. In fact, the dimensions of the different features may be arbitrarily increased or reduced for clarity of discussion. In addition, the present disclosure may repeat reference numerals and/or letters in the various examples. This repetition is for simplicity and clarity and does not in itself dictate a relationship between the various embodiments and/or configurations discussed.

FIG. 1 is an illustrative block diagram representing an example computing system that includes a networking data processing unit (DPU) operatively coupled between a host system and an external network in accordance with some embodiments.

FIG. 2 is an illustrative drawing representing an example packet in accordance with some embodiments.

FIG. 3 is an illustrative block diagram showing certain details of an example parser in accordance with some embodiments.

FIGS. 4A-4B are illustrative drawings representing an example header type identifier data structure (FIG. 4A) and packet offset data structure (FIG. 4B) in accordance with some embodiments.

FIG. 5 is an illustrative flow diagram representing operations of the example parser in accordance with some embodiments.

FIG. 6 is an illustrative block diagram showing certain details of match logic in accordance with some embodiments.

FIG. 7 is an illustrative drawing representing a method of operating a MISA processor as a logical pipeline in accordance with some embodiments.

FIG. 8 is an illustrative drawing showing an example first packet, in accordance with some embodiments.

FIG. 9 is an illustrative drawing representing an example first packet type identification (PTID) data structure generated based on the example packet of FIG. 8 in accordance with some embodiments.

FIG. 10 is an illustrative drawing representing an example first start-of-packet offset data structure generated based on the example packet of FIG. 8 in accordance with some embodiments.

FIG. 11 is an illustrative drawing representing an example first payload offset data structure generated based on the example packet of FIG. 8 in accordance with some embodiments.

FIG. 12 is an illustrative drawing showing an example second packet that includes a tunnel overlay section and a tunnel underlay section in accordance with some embodiments.

FIG. 13 is an illustrative drawing representing an example second PTID data structure that includes multiple sections, each section corresponding to a tunnel layer of the example second packet of FIG. 12 in accordance with some embodiments.

FIG. 14 is an illustrative drawing representing an example second start-of-packet offset data structure that includes multiple sections, each section corresponding to a different tunnel layer of the second packet of FIG. 12 in accordance with some embodiments.

FIG. 15 is an illustrative drawing representing an example second payload offset data structure that includes multiple sections, each section corresponding to a different tunnel layer of the second packet of FIG. 12 in accordance with some embodiments.

### DETAILED DESCRIPTION

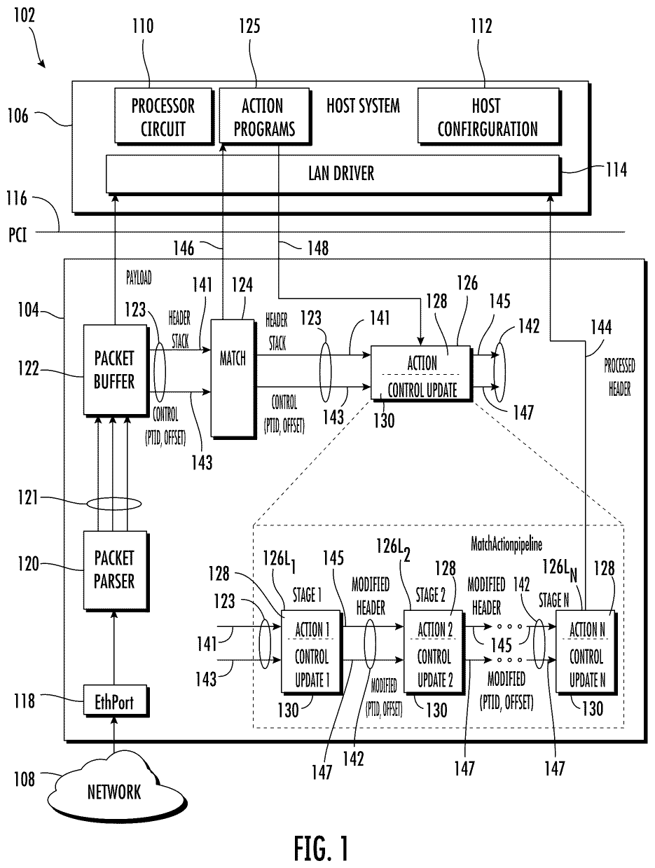

FIG. 1 is an illustrative block diagram representing an example computing system 102 that includes a networking data processing circuit 104 operatively coupled between a host processing system 106 and an external network 108. An example host system 106 includes a general-purpose computing machine that includes host processor circuitry 110 coupled to a non-transitory memory device 112 with instructions to configure the host processor circuitry 110 to provide networked services to one or more users or other computers (not shown). An example computing system 102 includes a PCIe bus communication system 116 that electronically communicates information between the host system 106 and the networking data processing circuit 104. An example networking data processing circuit 104 includes network interface 118, a packet parser 120, a packet buffer 122, match logic circuit 124, and a micro-instruction set (MISA) processor 126 used to implement an action pipeline 127. The memory device 112 stores a local area network (LAN) driver 114, a software program to configure the host system interface logic 114, and the data processing circuit 104 for effective transmission and reception of network packets. Network interface 118 may include one or more ports (only one shown) associated with managing the transfer of data received over the external network 108. Different ports may correspond to different network protocols. An example network interface 118 implements an Ethernet port.

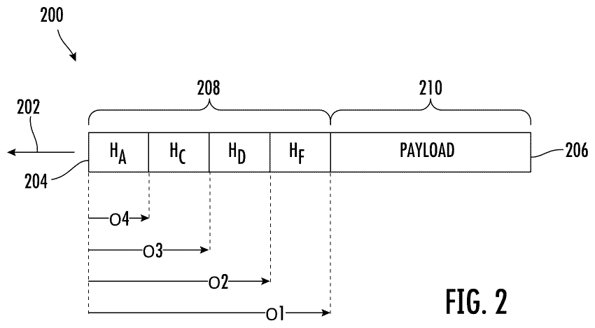

FIG. 2 is an illustrative drawing representing an example packet 200 that can be received at network interface 118. The packet includes a serial sequence of ordered bit values that travels through network 108 in the direction indicated by arrow 202. The example packet includes a head 204, which can be the leading edge of an example packet 200 that arrives first at the network interface 118, and a tail 206, which can be the trailing edge of packet 200 that arrives last at the network interface 118. More particularly, the example packet includes a header stack 208 with multiple example network headers H_{A}, H_{C}, H_{D}, and H_{F} arranged in a sequence and a payload 210. As indicated by the arrow 202, the header stack 208 arrives at the network interface 118 before the payload 210. Moreover, the network headers H_{A}, H_{C}, H_{D}, and H_{F} arrive at network interface 118 sequentially based on their sequential arrangement within the header stack 208. In the example packet 200, H_{A} arrives first, H_{C} arrives second, H_{D} arrives third, and H_{F} arrives fourth. The start of the payload 210 is offset by a first amount O1 from the start of the first header H_{A}, is offset by a second amount O2 from the start of the second header H_{C}, is offset by a third amount O3 from the start of the third header H_{D} and is offset by a fourth amount O4 from the start of the fourth header H_{F}. Offset amounts O1-O4 are measured in terms of the number of bits within the packet between the start of a respective header and the start of the payload. It is noted that a packet can include other information, such as error-correcting code, which is not shown to avoid complexity unrelated to the offset relationship between headers and payload.

Referring to FIG. 1, the packet parser 120 is coupled to receive packets transferred from the external network 108 over the network interface 118. The packet parser 120 can be implemented as an application-specific integrated circuit (ASIC) configured to inspect the headers and payload of a received packet and generate header arrangement information that identifies individual headers within the packet's header stack and offsets between the individual headers and the payload.

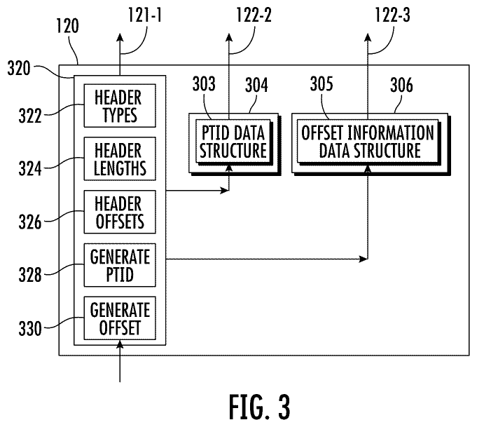

FIG. 3 is an illustrative block diagram showing certain details of an example parser 120 in accordance with some embodiments. Parser 120 header processing logic 320 and first and second storage media 304, 306. The header processing logic 320 includes header type identifier logic circuit 322, header length determination logic circuit 324, header offset determination logic circuit 326, header type information generation logic circuit 328, and offset information generation logic circuit 330. The header identifier logic 322 and header length determination logic 324 operate on headers within a packet's header stack in the order in which they are received over the network 108. Knowledge of a header's type connotes knowledge of the location of fields within the header. A first-arriving header type in a packet is typically fixed for a given network and thus known by the example inspection logic 302 (e.g., Ethernet). Thus, header identifier logic 322 knows field locations within the first header of a received packet. Headers of a received packet typically include a next header field that identifies header type of a next header type in the packet's header stack. The header identifier logic 322 inspects next header fields of headers in a header stack to identify header types of a sequence of headers in the packet's header stack. Headers of a received packet typically include a header length field that indicates the length of the current header. The header length determination logic 324 inspects the header length fields of headers in a header stack to determine lengths of headers in the stack. Header offset determination logic 326 determines the offset of the leading edge of each identified header in the header stack from the packet payload based upon a sum of the header lengths between the leading edge of the identified header and the packet's payload. Header type information generation logic 328 determines header identifying information to insert in a predetermined PTID schema to produce a header identifying information data structure that corresponds to a network packet, based upon header types identified within the packet's header stack. More specifically, the header type information generation logic 328 causes one or more bits within elements of the PTID data structure 303 to be set to indicate header types within a packet header. The PTID data structure 303 can be stored in a first non-transitory memory media 304, which can include a register circuit. It will be appreciated that different packet types have different combinations of packet headers. Offset information generation logic 330 determines offset indicating information to insert into a predetermined offset schema to produce an offset data structure that corresponds to a network packet, based upon header type offsets determined for the packet's header stack. More specifically, the offset information generation logic 330 causes offset values to be stored within elements of an offset data structure 305. The offset data structure 305 can be stored in a second non-transitory memory media 306, which can include a register circuit. Individual offset values stored in the offset data structure 305 indicate offsets between the payload and corresponding headers identified in the PTID data structure 303. The parser 120 outputs the packet on lines 121-1 to the buffer 122. The parser 120 outputs the PTID data structure on lines 121-2 to the buffer 122. The parser 120 outputs the offset data structure on lines 121-3 to the buffer 122.

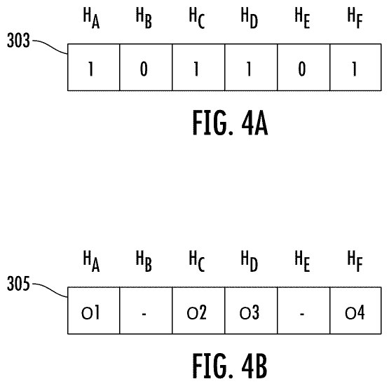

FIGS. 4A-4B are illustrative drawings representing an example packet type identifier data structure (FIG. 4A) and payload offset data structure (FIG. 4B) in accordance with some embodiments. A packet type identifier data structure 303 of FIG. 4A has a predetermined schema that includes a storage element for each of multiple predetermined header types; each storage element corresponds to a different predetermined header type. Logic Information stored at storage elements within an instance of the header type schema indicates header types within a packet header stack that correspond to the instance of the header type schema. A payload offset information data structure 305 of FIG. 4B has a predetermined schema that includes a storage element for each of multiple predetermined header types; each storage element corresponds to a different predetermined header type. Offset values stored at storage elements within an instance of an offset schema indicates payload offsets of header types within a packet header stack that correspond to the instance of the offset schema.

The illustrative example in FIGS. 4A-4B assumes six relevant header types: H_{A}, H_{B}, H_{C}, H_{D}, H_{E}, and H_{F}. The example PTID data structure 303 includes a plurality of elements, each corresponding to a different header type and each to store a binary value indicative of whether the header type to which it corresponds is present in a received packet. The example data offset data structure 305 also includes a plurality of elements, each corresponding to a header type in the PTID data structure 303 and each to store a value indicative of an offset amount between a received packet's payload and a start of the header within the received packet to which it corresponds. Assuming that the parser 120 receives the example packet 200 of FIG. 2, which includes header types H_{A}, H_{C}, H_{D}, and H_{F}, the elements of the first data structure 303 corresponding to packet types H_{A}, H_{C}, H_{D}, and H_{F} are set (e.g., to logic 1) and the remaining elements of the first data structure 303 H_{B} and H_{E} are not set (e.g., logic 0). Correspondingly, the elements of the second data structure 305 corresponding to packet types H_{A}, H_{C}, H_{D}, and H_{F} have offset values O1, O2, O3, and O4, and the remaining elements of the second data structure 305 H_{B} and H_{E} have no offset values. Since not every header type is included within a typical received packet, some offset data structure 305 elements can be empty.

An example PTID 303 comprises an array-type data structure, and an example offset data structure 305 also comprises an array-type data structure. The PTID data structure 303 and the offset structure 305 also are collectively referred to herein as ‘header stack arrangement information’ since they indicate the arrangement of headers within a header stack. The PTID data structure 303 indicates headers included within a packet header stack, and the offset structure 305 indicates the location of the headers within the packet header stack. The offsets of the individual headers from the payload also indicate the order in which the headers are received over network 108.

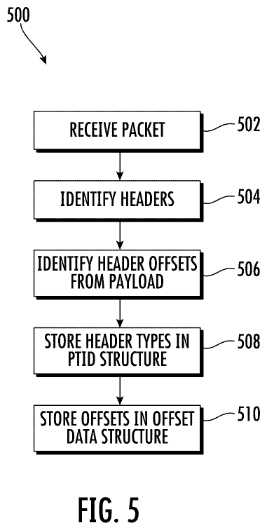

FIG. 5 is an illustrative flow diagram representing a method 500 performed using the example parser 120 of FIG. 3. The inspection logic 302 is configured to perform the operations shown in FIG. 3. Operation 502 receives a packet. Operation 504 identifies headers within the packet and the start of a packet payload within the packet. Operation 506 identifies the offsets between the start/leading edge of each identified header and the start/leading edge of the packet's payload. Operation 508 stores header identifier information identifying each header type identified within the packet. More specifically, an example operation 508 stores the header type information in a PTID data structure 303. Operation 510 inserts offset information indicating the offset between the payload and the start/leading edge of the header for each identified header. More specifically, an example operation 510 stores offset information in an offset structure 305.

Referring to FIGS. 1-2, parser 120 forwards the packet, PTID data structure, and offset information on lines 121 to the packet buffer circuit 122. The buffer circuit 122 uses the offset information to locate the starting boundary between packet header 208 and payload 210. The buffer circuit 122 splits the packet's header stack 208 from the packet's payload 210. The buffer circuit 122 transmits the payload 210 on line 141 to bus 116 for transmission to the host system interface logic 114 to the host processor circuitry 110. The example buffer circuit 122 transmits the packet's header stack, PTID, and offset information on lines 123 to the match logic circuit 124. The example buffer circuit 122 also transmits the packet's header stack, PTID, and offset information on lines 123 to the MISA processor 126. It will be understood that the term “line” as used herein is used to refer to a set of one or more data conductors.

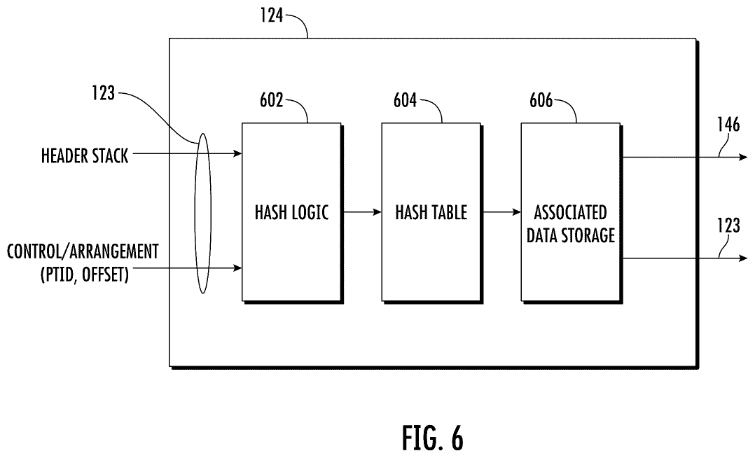

FIG. 6 is an illustrative block diagram showing certain details of example match logic circuit 124 in accordance with some embodiments. The example match logic 124 is used to associate a received header stack with computer program instructions stored in an action program memory 125. The match logic includes hash logic 602, hash table 604, and associated data storage memory 606. The hash logic 602 generates a hash value based, at least in part, on a search key that includes at least a portion of a received header stack. More particularly, example hash logic 602 can generate a hash key based on at least a portion of a received header stack and a portion of packet arrangement information (e.g., PTID and offset information). An example hash table 604 includes a ternary content addressable memory (TCAM). Different memory locations within the TCAM store different binary values that identify different memory locations within the associated data storage memory 606. The associated data storage memory 606 includes random access memory (RAM) that stores address information used to locate different action programs within memory 125. Different action programs are used to implement rules for modifying different header stacks. During a match operation, the hash logic 602 generates a hash value based at least in part upon a received packet's header stack. A binary value stored at a memory location of the hash table 604 that matches the hash value is used to identify a memory location within the associated memory 606, where address information is stored that is used to identify the location of an action program within memory 125 to be used to process the packet's header stack. An action program configures the MISA processor 126 to implement the action pipeline 127 to perform one or more associated sets of actions. The action program memory 125 can store multiple sets of program instructions, each set of program instructions (e.g., an action program) corresponding to a different configuration of the MISA processor 126. The example match logic 124 produces an associated data signal on line 146 that causes the selection of a set of program instructions that matches a received packet's header stack, used to configure the processor 126 to process the header stack. Each set of program instructions in the action program memory 125 includes one or more memory pages. Details of example match logic 104 are provided in commonly owned U.S. Pat. No. 11,922,032, which is expressly incorporated herein in its entirety by this reference.

Referring to FIG. 1, an example MISA processor 126 executes instructions of an action program. The MISA processor 126 includes input lines 123 that include line 141 that provides a header stack and that include line 143l that provides control information that includes a PTID data structure 303 and a corresponding offset data structure 305. The MISA processor 126 includes output lines 142 that include line 145 that provides an updated header stack and that includes line 147 that provides updated header control/arrangement information that includes an updated PTID data structure and updated offset information data structure. The updated PTID data structure and the updated offset data structure provided at line 147 may be updated based upon changes made to the header stack received at line 141 by the MISA processor 126.

An action program stored in action program memory 125 may include multiple sets of action program instructions that can be provided in sequence on line 148 to configure the MISA processor 126 to perform a sequence of actions to modify a packet header received at line 141. During packet processing, MISA processor 126 can use control/header arrangement information that includes the packet's PTID data structure to identify header types in a received header stack and can use the packet's PTID data structure together with the packet's offset data structure to locate identified header types and/or to locate header fields within the identified header types. As explained above, persons skilled in the art will understand that header types generally have predefined fields and that once a header type is identified using the PTID data structure and a location of the header type within a header stack is identified using the offset data structure, header fields within the identified header type can be located based upon the predefined layout of fields within the header type.

The MISA processor 126 includes programmable action logic 128 that can be configured with a sequence of sets of action program instructions to perform actions to modify the header stack in stages. Modifying a header stack can include modifying a portion of the header stack. Modifying a portion of the header stack can include adding a header or adding information to an existing header. Modifying a portion of the header stack can include deleting a header or deleting information within an existing header. Modifying a portion of the header stack can include shifting the location of a header within the header stack or shifting information within an existing header. Modifying a portion of a header within a header stack can include shifting header bytes to make space for adding header bytes, adding header bytes, deleting header bytes, and/or replacing header bytes with new header bytes. The term header bytes can include header fields within an individual header in the header stack or an entire header in the header stack. During the shifting and/or modifying operations, action logic 128 can use a packet's PTID data structure to identify header types in a received header stack and can use the packet's offset data structure to locate header fields within the identified header types. Action logic 128 outputs a modified header stack.

The MISA processor 126 also includes programmable control update logic 130 that can be configured with a set of action program instructions to update a packet's PTID data structure and to update the packet's offset data structure based upon adds, deletes, shifts of bits or bytes within a header stack and/or other operations performed using the action logic 128. The control update logic 130 generates an updated PTID data structure on line 147 that indicates header types currently present within the header stack following the most recently performed operations of action logic 128. The control update logic 130 also generates an updated offset data structure on line 147 that indicates current header offsets from the payload following the most recently performed operation performed by action logic 128. The control update logic 130 outputs updated control information that includes updated PTID and corresponding updated offset information.

As indicated by the dashed-line block in FIG. 1, the misa processor 126 can operate as a logical pipeline 127 comprising multiple logical pipeline stages 126L₁-126Lₙ in which successive logical stages perform different actions on successively modified versions of a header stack and in which an input to a logical stage in the pipeline 127 is an output of a previous logical stage in the pipeline 127. Each different logical stage represents the processor 126 configured using a different set of action program instructions provided on line 148. Thus, match logic 124 can be used to identify an action program in memory 125 that produces a sequence of action program instructions that cause the multiple logical pipeline stages 126L₁-126Lₙ to perform a sequence of actions to process a received packet header. Each set of action program instructions can be arranged as a separate page of instructions.

More particularly, a set of action program instructions configures a logical stage 126L₁ of the pipeline 127 to generate first modified header stack on lines 145 and to generate first modified arrangement information on line 147. A next set of action program instructions configures a next logical stage 126L₂ of the pipeline 127 to generate second modified header stack on lines 145 and to generate second modified arrangement information on line 147, based upon the first modified header stack and the first modified arrangement information. Successive logical stages in the pipeline operate with one another in a similar manner. Thus, the MISA processor 126 modifies header arrangement information, (e.g., PTID and offset data structures) in tandem with changes to the header stack so that the changes in the header arrangement information keep up to date with changes to the header stack. U.S. patent application Ser. No. ______, entitled Micro Instruction Set Architecture Packet Processor (MLO Ref: DREAP010), filed on even date herewith, which is expressly incorporated herein in its entirety by this reference.

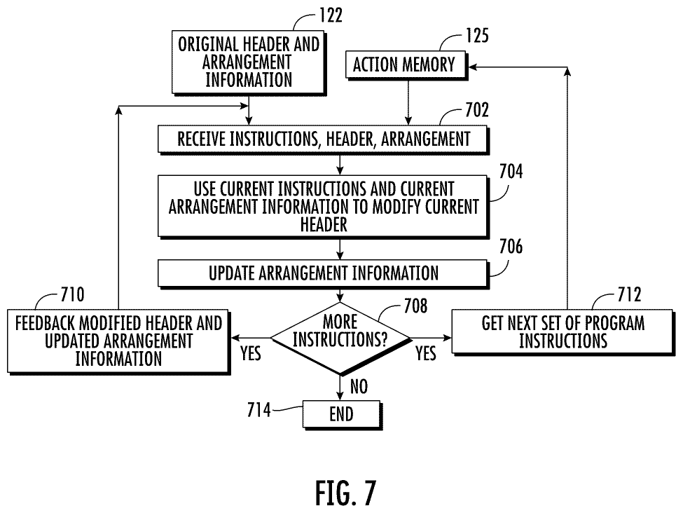

FIG. 7 is an illustrative drawing representing process 700 of operating a MISA processor 126 as a logical pipeline in accordance with some embodiments. The MISA processor 126 is configured to perform the operations of process 700. Operation 702 receives from packet buffer 122 an original packet header stack received from the network 108 and original arrangement information (e.g., PTID and offset data structures) generated using parser 120. Operation 702 also receives a first set of action program instructions from action program memory 125. Operation 704 uses the MISA processor's action logic 128 to modify a currently received packet header. Operation 704 uses currently received arrangement information to identify headers and locate header types within a currently received header stack. Operation 706 uses the MISA processor's control update logic 130 to update the currently received arrangement information based upon changes to the currently received header stack. Decision operation 708 determines whether the currently received set of action program instructions indicates that the action program includes a next set of action program instructions. In response to a determination that the currently received set of action program instructions includes a next set of action program instructions, operation 710 causes feedback of the currently modified header and the currently updated arrangement information, which are received as next input to the MISA processor 126. Also, in response to a determination that the currently received set of action program instructions include a next set of action program instructions, operation 712 causes the action program memory 125 to send the next set of action program instructions which are received as input to the MISA processor 126. Also, in response to a determination that the currently received set of action program instructions include a next set of action program instructions, control flows back to operation 704. In response to a determination that the currently received set of action program instructions does not include a next set of action program instructions, then the process 700 ends 714.

Significantly, modification of the packet type header identifier (PTID) and header offset information at successive action logical pipeline stages 126L₁-126Lₙ based upon changes imparted to a packet's header stack at the successive logical pipeline stages allows subsequent pipeline stages to locate and extract fields from modified header stacks without the need to reparse the packet to determine updated PTID and/or updated offset information between logical pipeline stages.

### Example—Packet Parser: Parsing a Packet to Create PTID and Offset Data Structures

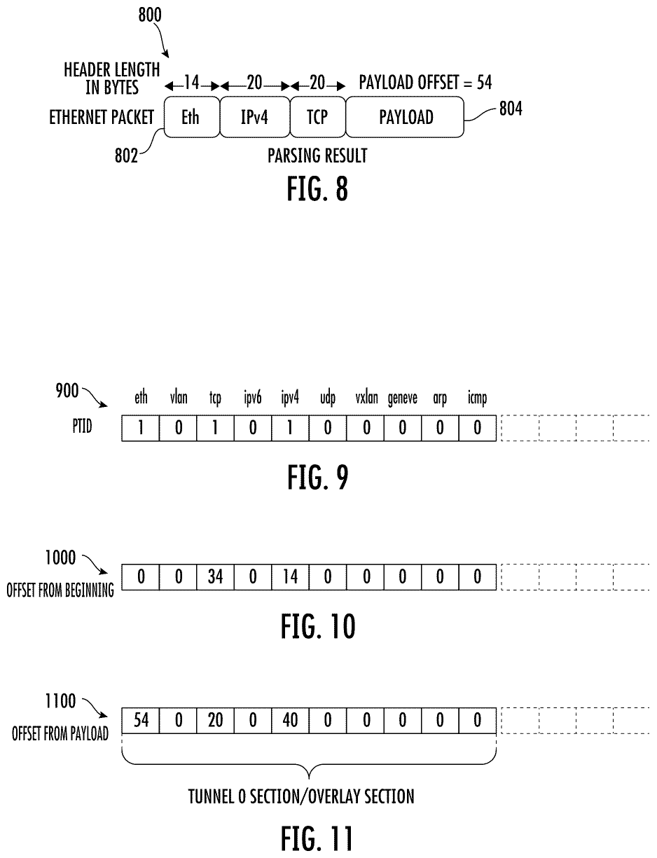

FIG. 8 is an illustrative drawing showing an example first packet 800 that includes an Ethernet header, an IPv4 header, and a TCP header. The packet includes a head-end portion 802 and a tail-end portion 804. The arrow indicates the header transmission direction. The head of the packet is the start of the packet, which is the first portion of the packet to arrive at the parser 120. The packet 800 includes an Ethernet header with length fourteen (14) units, an IPv4 header with length twenty (20), and a TCP header with length twenty (20) units. The packet 800 includes a payload offset by fifty-four (54) units from the start 802 of the packet 800. It is noted that the payload offset from the start of the packet is the sum of the packet lengths of the three headers in the header stack that precede the payload in the packet. Header lengths and offset amounts can be represented in terms of units measured in the number of bytes. In alternative embodiments, header lengths and offset amounts can be represented in terms of units measured in the number of bits or words, for example.

The parser 120 parses packet 800 to generate a corresponding PTID and offset information. The parser includes logic configured to arrange header-type information in a PTID data structure and to arrange corresponding offset information in an offset data structure. FIG. 9 is an illustrative drawing representing an example first PTID data structure 900 generated for packet 800. FIG. 10 is an illustrative drawing representing an example of a first start-of-packet offset data structure 1000 generated for packet 800, with offset amounts measured from the head 802 of the packet to the start of each header within the packet. The ‘start’ of each header is the leading edge of the header that is nearest to the start of the packet 802. FIG. 11 is an illustrative drawing representing an example first payload offset data structure 1100 generated for the packet 800 with offset amounts measured from the packet's payload.

The first PTID data structure 900 of FIG. 9 includes an array of single-bit storage elements in which each element corresponds to a different header type from a set of header types. A logic value of a bit stored at an element of the array indicates whether a header stack within a received packet contains a header type corresponding to the element. In an example first PTID structure, a logic 1 value indicates the presence of a corresponding header type, and a logic value 0 indicates the absence of the corresponding header type. An example packet parser 120 ‘sets’ a bit value to logic 1 in response to the presence of a corresponding header type and ‘resets’ a bit value to logic 0 in response to the absence of a corresponding header type.

The first start-of-packet offset data structure 1000 and first payload offset data structure 1100 of FIGS. 10-11, respectively, each includes an array of offset storage elements, in which each element corresponds to a different header type from the set of header types. Elements of the first offset data structure store values representing offsets from the start of the packet. Elements of the second offset data structure store values representing offsets from the packet payload.

The example first PTID data structure 900 of FIG. 9 and the example offset data structures 1000, 1100 of FIGS. 10-11 each is configured to include an array with ten (10) storage elements, each element corresponding to one of the following header types: Ethernet, VLAN, TCP, IPv6, IPv4, UDP, VXLAN, Geneve, ARP, and ICMP. Referring to FIG. 8, the example packet 800 includes an Ethernet header, an IPv4 header, and a TCP header, having lengths (14), (20), and (20), respectively. Accordingly, elements of the example first PTID data structure 900 shown in FIG. 9 that correspond to the Ethernet, IPv4, and TCP header types are set (logic 1), and the other elements are reset (logic 0). Moreover, elements of the first start-of-packet offset structure 1000 of FIG. 10 that correspond to the Ethernet, IPv4, and TCP header types contain values representing offsets from the start of the packet of corresponding headers, and the other elements contain no offset information. Specifically, in the first offset data structure, the Ethernet element indicates an offset of (0) from the beginning of the packet, the IPv4 element indicates an offset of (14) from the beginning of the packet, and the TCP element indicates an offset of (34) from the start of the packet 800. Conversely, elements of the first payload offset structure 1100 of FIG. 11 that correspond to the Ethernet, IPv4, and TCP header types contain values representing offsets from the payload, and the other elements contain no length information. Specifically, in the first payload offset data structure 1100, the Ethernet element indicates an offset of (54) from the packet payload, the IPv4 element indicates an offset of (40) from the packet payload, and the TCP element indicates an offset of (20) from the packet payload.

As explained above, an example parser 120 first determines header offsets measured from the start of packet 802, as indicated in the example first start-of-packet offset structure of FIG. 10. Parser 120 then uses the start of packet offsets to calculate header offsets measured from the payload as indicated in the example first payload offset structure 1100 of FIG. 11. The example payload offset structure is used as offset information is forwarded to the buffer for use in the MISA processor 126. As will be appreciated from the following description, an advantage of the use of offsets measured from the payload is that tunnel insertions and removals happen at the start portion of the packet. If the header offsets are measured from the start of the packet, then all original header offsets require adjustment in case of tunnel insertion or removal (e.g. if the tunnel contains ‘n’ bytes, add ‘n’ bytes to each header offset for tunnel insertion and tunnel remove ‘n’ bytes from each header offset for removal). Having header offsets measured from the payload does not require adjustment of header offsets of headers that were present in the packet before inserting or removing tunnels from the packet, which reduces compute effort.

### Example—Packet Parser: Parsing a Packet having an Underlay Tunnel to Create PTID and Offset Data Structures

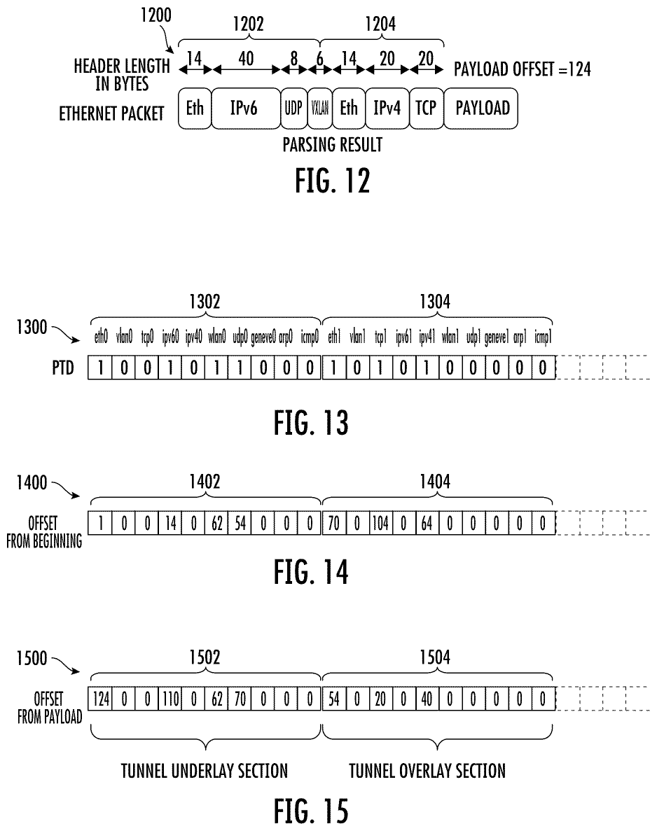

FIG. 12 is an illustrative drawing showing an example second packet 1200 that includes a tunnel underlay section and a tunnel overlay section. Each respective tunnel section comprises a respective header stack. A tunnel underlay section is used to transport a packet over an underlay network. A tunnel overlay section is used to create virtual links (tunnels) between endpoints over a physical underlay network. In networking, the terms ‘overlay’ and ‘underlay’ refer to different layers of a network architecture. An underlay network typically includes physical hardware and infrastructure, such as routers, switches, and cables, that provide basic connectivity and transport capabilities. An overlay network uses network virtualization techniques to create a logical network on top of an underlay network to provide additional services and functionalities. The creation of an overlay network often involves encapsulating packets within other packets using tunneling protocols such as VXLAN, GRE, or IPSec.

The tunnel underlay section in the example packet 1200 includes the following sequence of header types (and lengths): Ethernet (length 14); IPv6 (length 40); UDP (length 8); VXLAN (length 8). The VXLAN is referred to as a ‘tunnel header’ and represents a technology that creates an overlay tunnel network on top of the underlay tunnel network. The tunnel overlay section in the example packet 1200 includes the following sequence of headers (and lengths): Ethernet (length 14); IPv4 (length 20); TCP (length 20). The payload has a length of one hundred and twenty-four (124).

An example PTID data structure corresponding to a packet with more than one tunnel section includes multiple sections, each corresponding to a different tunnel section of the packet. Different sections of a multi-section PTID data structure have identical mappings between header types and PTID elements. FIG. 13 is an illustrative drawing representing an example second PTID data structure 1300 that includes multiple sections, each corresponding to a tunnel section of the example second packet 1200 of FIG. 12. The second PTID data structure 1300 includes a first section with elements corresponding to the following header types being set (e.g., logic 1): Ethernet, IPv6, UDP, and VXLAN. All other elements in the first section are reset (e.g., logic 0). The second PTID data structure includes a second section with elements corresponding to the following header types being set (e.g., logic 1): Ethernet, IPv4; TCP. All other elements in the second section are reset (e.g., logic 0).

The parser 120 parses packet 1200 to generate the corresponding example second PTID 1300. In response to identifying a ‘tunnel layer’ header type, such as a VXLAN header, that indicates the presence of multiple tunnel sections, the parser 120 creates a PTID that includes multiple sections 1302, 1304, each with an identical set of storage elements, and each different section corresponding to a different tunnel layer. A memory element corresponding to the tunnel layer header type is set in an underlay section 1302 of the example second PTID 1300 corresponding to headers in the header stack that precede the tunnel layer header type in the header stack. If a packet contains only an underlay header stack, then only the lowest order tunnel section 1302 of a PTID data structure is valid. As explained below, an example parser 120 can generate offset data structures 1400 and 1500 corresponding to the example second packet 1200 with multiple sections, each section corresponding to a different tunnel section of the packet 1200. Different sections of a multi-section offset data structure have identical mappings between header types and offset value elements.

FIG. 14 is an illustrative drawing representing an example second start-of-packet offset data structure 1400 that includes multiple sections 1402 and 1404, each corresponding to a different tunnel section of the second packet 1200, with offset information measured from the head of the second packet 1200. FIG. 15 is an illustrative drawing representing an example second payload offset data structure 1500 that includes multiple sections 1502 and 1504, each corresponding to a different tunnel section, with offset information measured from the packet payload. An example packet parser 120 includes logic configured to calculate offset information from the start of each header in packet 1200 to the start of packet 1200 and to record the payload offset information in the example start-of-packet offset data structure 1400. The parser 120 includes logic to calculate offset information for entry into the example second payload offset data structure 1500. More particularly, parser 120 includes logic to deduct offsets recorded in the second start-of-packet offset data structure 1400 from the payload offset to generate offsets in the second payload offset data structure offset data structure 1500.

Referring to FIG. 14, elements of a first section 1402 of the example second start-of-packet offset data structure 1400 offset structure that corresponds to the first section 1202 of the example second packet 1200 (i.e., Ethernet, IPv6, UDP, VXLAN) contain values representing offsets from the start of the packet 1200 to the start of each header, and the other elements of the first section contain no offset information. Elements of a second section 1404 of the example second start-of-packet offset structure 1400 that correspond to the second section 1204 of the example second packet 1200 (i.e., Ethernet, IPv4, TCP) contain values representing offsets from the start of the packet 1200 to the start of each header, and the other elements of the second section contain no offset information.

Referring to FIG. 15, elements of a first section 1502 of the example second payload offset data structure 1500 that correspond to the first section 1202 of the example second packet 1200 (i.e., Ethernet, IPv6, UDP, VXLAN) contain values representing offsets from the packet's payload to the start of each header, and the other elements of the first section 1502 contain no offset information. Elements of a second section 1504 of the example second payload offset data structure 1500 that correspond to the second section 1204 of the example second packet 1200 of (i.e., Ethernet, IPv4, TCP) contain values representing offsets from the packet's payload to the start of each header, and the other elements of the second section 1504 contain no offset information.

### Example—Pipeline Stage: Encapsulation

The action logic 128 of the MISA processor 126 can be configured to perform an encapsulation action in which a tunnel section is appended to a header stack of the first packet 800. For example, the action logic 128 can be configured to encapsulate the first packet 800 received over the network 108 at the parser 120 shown in FIG. 8, which includes a single tunnel overlay section, to generate the second packet 1200 shown in FIG. 12 that includes two tunnel sections, a tunnel underlay section 1202, and a tunnel overlay section 1204.

The control update logic 130 of the MISA processor 126 updates the first PTID data structure 900 of FIG. 9 to generate the second PTID data structure 1300 of FIG. 13 and updates the first payload offset data structure 1100 of FIG. 11 to generate the second payload offset data structure 1500 of FIG. 15. It is noted from a comparison of the first and second payload offset data structures 1100 and 1500 that the encapsulation action does not require a change in payload offset information for the tunnel overlay section 1504. In other words, the offsets in the payload overlay section 1504 of the second payload offset data structure 1500 corresponding to the updated packet header stack of second packet 1200 are identical to the payload offsets within the first payload offset data structure 1100 for the original packet 800. Thus, there is no need to parse the second packet 1200 to determine offsets in the second payload offset data structure 1500.

### Example—Pipeline Stage: Decapsulation

The action logic 128 of the MISA processor 126 can be configured to perform a decapsulation action in which a tunnel section is removed from a header stack of the second packet 1200. For example, the action logic 126 can be configured to decapsulate the tunnel underlayer section 1202 of the second packet 1200 received over the network 108 at the parser 120 shown FIG. 12 to generate the header stack of the first packet 800 shown in FIG. 8.

The control update logic 130 of the MISA processor 126 updates the second PTID 1300 of FIG. 13 to generate the first PTID 900 of FIG. 9 and updates the second payload offset data structure 1500 of FIG. 15 to generate the first payload offset data structure 1100 of FIG. 11. It is noted from a comparison of the first and second payload offset data structures 1100 and 1500 that the decapsulation action does not require a change in payload offset information for the tunnel overlay section 1504. In other words, the payload offsets within the first payload offset data structure 1100 corresponding to the updated packet header stack of the first packet 800 are identical to the payload overlay section 1504 of the second payload offset data structure 1500 corresponding to the original packet header stack of packet 1200. Thus, there is no need to reparse the first packet 800 to determine offsets in the first payload offset data structure 1100.

### Example—Pipeline Stages-Other Actions

Encapsulation and decapsulation are two actions that an individual example pipeline stage may be configured to perform. In addition to encapsulation and decapsulation, pipeline stages may be configured to perform other actions, such as insertion or removal of VLAN tags, insertion or removal of IPv6 extensions, and insertion or removal of MPLS tag(s).

The above description is presented to enable any person skilled in the art to create and use a network data processing circuit. Various modifications to the embodiments will be readily apparent to those skilled in the art, and the generic principles defined herein may be applied to other embodiments and applications without departing from the spirit and scope of the invention. In the preceding description, numerous details are set forth for the purpose of explanation. However, one of ordinary skill in the art will realize that the embodiments in the disclosure may be practiced without the use of these specific details. In other instances, well-known processes are shown in block diagram form so as not to obscure significant aspects of the disclosure with unnecessary detail. Identical reference numerals may represent different views of the same or similar item in different drawings. Thus, the foregoing description and drawings of examples in accordance with the present invention are merely illustrative of the principles of the invention. Therefore, it will be understood that various modifications can be made to the embodiments by those skilled in the art without departing from the spirit and scope of the invention, which is defined in the appended claims.

1. A network packet parser circuit comprising:
logic to identify header types within a network packet;
logic to determine offsets of the identified header types from a payload of the packet;
logic to generate header arrangement information that indicates packet header types within the network packet and packet header locations within the packet header.

2. The network packet parser of claim 1 further including:
logic to identify lengths of the identified header types within the network packet;
wherein the logic to determine offsets of the identified header types from a payload of the packet determines the offsets based upon the identified lengths of the identified header types within the network packet.

3. The network packet parser of claim 2,
wherein the logic to identify lengths of the identified header types within the network packet includes logic to inspect header length fields within headers of the network packet. The network packet parser of claim 1,
wherein the logic to identify header types includes logic to inspect next packet type fields within headers of the network packet.

5. The network packet parser of claim 1,
wherein the logic to generate header arrangement information includes:
logic to insert header type information to a predetermined packet identification type schema to produce a packet type data structure that corresponds to the network packet, based upon the identified packet header types; and
logic to insert header offset information using a predetermined header offset schema to produce a header offset data structure that corresponds to the network packet, based upon the determined offsets of the identified header types from a payload of the packet; further including:
first non-transitory storage media to store the packet type identifying data structure; and
second non-transitory storage media to store the header offset data structure.

6. The network packet parser of claim 5,
wherein the predetermined packet identification type schema comprises an array structure; and
wherein the predetermined header offset schema comprises an array structure.

7. The network packet parser of claim 1,
wherein the logic to determine offsets of the identified header types from a payload of the packet determines offsets of packets from a start of the network packet and determines offsets of the identified header types from a payload based upon the determined offsets of the identified header types from the start of the network packet.

8. A network packet parser circuit comprising:
logic to identify header types within a network packet;
logic to determine offsets of the identified header types from a payload of the packet;
logic to insert header type information in a predetermined packet identification type schema to produce a packet header type data structure that corresponds to the network packet, based on the identified packet header types; and
logic to insert header offset information in a predetermined header offset schema to produce an offset data structure that corresponds to the network packet, based on the determined offsets.

9. The network packet parser circuit of claim 8 further including:
first non-transitory storage media to store the header type information; and
second non-transitory storage media to store the header offset information.

10. The network packet parser of claim 8,
wherein the predetermined packet identification type schema comprises an array structure;
wherein the predetermined header offset schema comprises an array structure; and
wherein header type information provides index information that associates corresponding locations within the PTID data structure schema and the offset data structure schema.

11. The network packet parser of claim 8, further including:
logic to identify lengths of the identified header types within the network packet;
wherein the logic to determine offsets of the identified header types from a payload of the packet determines the offsets based upon the identified lengths of the identified header types within the network packet.

12. A method to parse a network packet comprising:
using a logic circuit to identify header types within a network packet;
using a logic circuit to determine offsets of the identified header types from a payload of the packet;
using a logic circuit to insert header type information in a predetermined header identification type data structure schema to produce a header type data structure that corresponds to the network packet, based upon the identified packet header types; and
using a logic circuit logic to insert header offset information in a predetermined header offset data structure schema to produce an offset data structure that corresponds to the network packet, based upon the determined offsets of the identified header types from a payload of the packet.

13. The method of claim 12 further including:
storing the header type data structure in first non-transitory storage media; and
storing the offset data structure in second non-transitory storage media.

14. The method of claim 12 further including:
using logic to identify lengths of the identified header types within the network packet;
using logic to determine offsets of the identified header types from a payload of the packet includes using logic to determine based upon the identified lengths of the identified header types within the network packet.

15. A network packet processing circuit to modify a packet received over a network that includes a header stack and a payload comprising:
packet parser circuit comprising:
logic to identify header types within a network packet;
logic to determine offsets of the identified header types from a payload of the packet;
logic to insert header type information in a predetermined packet identification type schema to produce a header type data structure that corresponds to the network packet, based on the identified packet header types; and
logic to insert header offset information in a predetermined header offset schema to produce an offset data structure that corresponds to the network packet, based on the determined offsets; and
a processor circuit operatively coupled to a memory that includes a set of computer program instructions to cause the processor circuit to perform a set of operations, including:
using the header type data structure and the offset data structure to locate a first header within a header stack of the network packet;
modifying the located first header in the header stack to produce a modified header stack;
updating at least one of the header type data structure or the offset data structure based upon the modified header stack;
using the updated at least one of the header type data structure or the offset data structure to locate a second header within the modified header stack; and
modifying the located second header in the modified header stack to produce a further modified header stack.

16. The network packet processing circuit of claim 15,
wherein the memory includes multiple different sets of computer program instructions, each different set of computer program instructions to cause the processor circuit to perform a different set of operations; and further including:
a match logic circuit to match the header stack to a set of computer program instructions included in the memory to use to configure the processor circuit to perform the set of operations, based at least in part upon at least one of the header type data structure and the offset data structure.
